(19) United States
(12) Patent Application Publication
(10) Pub. No.: US 2017/0197326 A1
(43) Pub. Date: Jul. 13, 2017

(54) MANUAL PLATE CUTTING MACHINE

(71) Applicant: WENSHENG XU, QINGDAO (CN)

(72) Inventor: WENSHENG XU, QINGDAO (CN)

(21) Appl. No.: 15/351,111

(22) Filed: Nov. 14, 2016

(30) Foreign Application Priority Data
Jan. 11, 2016 (CN) 201620021827.5

(51) Int. Cl. B26D 5/10; B26D 7/02

(52) U.S. Cl. CPC B26D 5/10; B26D 7/025

(57) ABSTRACT

A manual plate cutting machine, comprises a workbench, a handle and a cutter, a front support and a rear support mounted on the workbench at intervals, wherein one end of the handle is in a gear shape, which is an active sector gear, coupled with the front support; the cutter comprises a cutter holder and a cutter body, the cutter body is mounted below the cutter holder, and one end of the cutter holder is in a gear shape, which is a passive sector gear, engaged with the active sector gear, and the other end of the cutter holder is coupled with the rear support. The present application optimizes the structure of a manual plate cutting machine. Compared with the traditional machine with reset spring structure, when cutting the plate, it is not required to overcome the elastic force of the reset spring, making it easy to cut.

### CROSS-REFERENCE TO RELATED APPLICATION

This application claims the priority benefit of Chinese application serial no. 201620021827.5, filed on Jan. 11, 2016. The entirety of the above-mentioned patent application is hereby incorporated by reference and made a part of this specification.

### FIELD OF THE INVENTION

This present application relates to a cutting device, in particular, to a manual plate cutting machine.

### BACKGROUND OF THE INVENTION

Plate cutting machines can be divided into two types: manual plate cutting machines and electric plate cutting machines. The electric plate cutting machines produce great noise and serious powder contamination, which are mainly used in the large-scale production; while a manual plate cutting machine is easy to carry, when paving floor boards, it can achieve cutting of floor boards according to the processing size. The workload for cutting is not heavy, thus, usually a manual plate cutting machine is used.

The patent (application number: CN201020103589.5) discloses an environment-friendly chip-free progressive cutter. Its structure is as follows: the handle is coupled with the nose at the top of the workbench, and an eccentric convex is arranged at the front end of the handle. The rear end of the cutter holder is coupled with a leg. A groove at the front end of the cutter holder is engaged with an eccentric convex; and a reset spring is provided between the workbench and the cutter holder. When working, the eccentric convex close to the handle presses the cutter holder along with the handle, to exert pressure on the groove at the front end of the cutter holder; at the end of cutting, when the handle is lifted, the cutter holder will not automatically reset, which can be reset by a reset spring. Since the contact between the eccentric cam and groove relies on an arc surface, a prolonged use will produce wear, affecting the pressing effect. The reset of cutter holder relies on the restoring force of the reset spring. When the reset spring is removed and the handle is lifted, the cutter holder will not automatically reset. A prolonged use of the reset spring will produce unrecoverable deformation, affecting the effect of reset of cutter holder and causing inconvenience for cutting.

### SUMMARY OF THE INVENTION

The present application aims at providing a manual plate cutting machine that is structurally sable and easy to carry.

The technology solutions are:

A manual plate cutting machine, comprises a workbench, a handle and a cutter, a front support and a rear support mounted on the workbench at intervals, wherein one end of the handle is in a gear shape, which is an active sector gear, coupled with the front support; the cutter comprises a cutter holder and a cutter body, the cutter body is mounted below the cutter holder, and one end of the cutter holder is in a gear shape, which is a passive sector gear, engaged with the active sector gear, and the other end of the cutter holder is coupled with the rear support. The rotation of active sector gear can drive the passive sector gear to rotate, therefore, the handle will drive to lift the cutter when lifting; and when falling, it will drive to fall down the cutter.

Preferably, a stop block is provided at a lower end of the handle. A limiting groove is provided on the cutter holder, and the limiting groove matches with the stop block. When pressing down the handle, the stop block will fall into the limiting groove. The stop block is a protrusion with a certain height. When pressing down the handle, the stop block and the limiting groove will limit the rotation of the handle. When operator continues to exert force on the handle, it will not continue to transmit to the workbench, extending the service life of the cutter body and the workbench.

Preferably, a handle fixing ring is provided at a tail end of the workbench, which can rotate around the tail end of the workbench and which is used to fix the handle.

Preferably, it further comprises a support frame with the same height as the workbench, and a support frame suspension mechanism is provided at a sidewall of the workbench. When the support frame is not in use, it can be hung on the sidewall of the workbench, to prevent missing.

Further, it still comprises a plate clamping mechanism which includes a clamping plate coupled with the workbench, and an elastic member is mounted at a low end face of the clamping plate. The spacing between the lower end surface of elastic member and a upper end face of the workbench depends on the thickness of the floor board.

The application can achieve the following beneficial effects:

Both the front end of the handle and the front end of cutter holder are in gear shape; both of which are engaged by the gear part and they can rotate synchronously. The engagement of gears is a stable connection. When the handle is lifted, it can automatically drive the cutter to lift. Compared with the reference in the Application No. CN 201020103589.5, it omits the reset spring structure, and it is simpler in structure and easier to use; in addition, when cutting the plate, it is not required to overcome the elastic force of the reset spring, and the cutting force is increased dramatically, making it easy to cut.

### BRIEF DESCRIPTION OF THE DRAWINGS

FIG. 1 shows the schematic diagram of the present application.

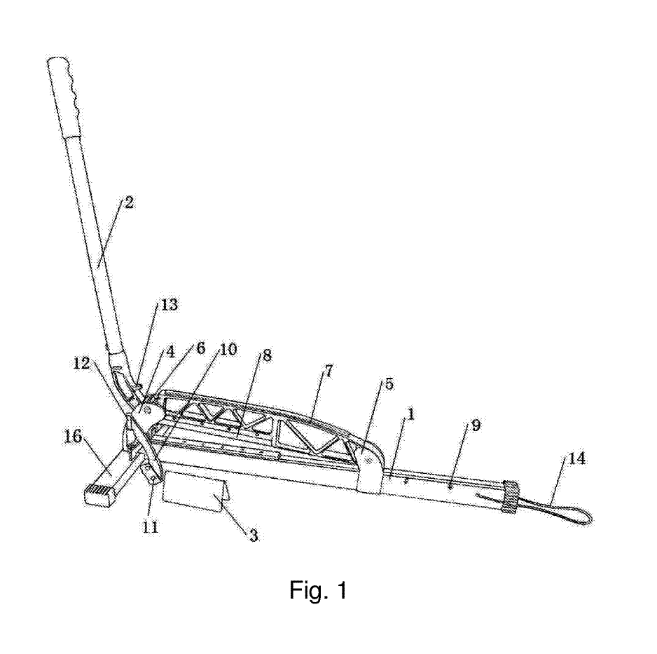

FIG. 2 shows the schematic diagram of the connection between a handle and a cutter holder.

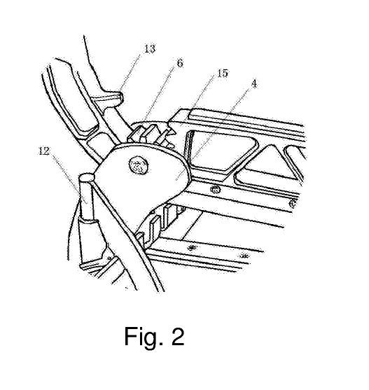

Of which, 1-workbench, 2-handle, 3-support frame, 4-front support, 5-rear support, 6-active sector gear, 7-cutter holder, 8-cutter body, 9-support frame suspension mechanism, 10- clamping plate, 11-elastic member, 12-clamping plate mounting shaft, 13-stop block, 14-handle fixing ring, 15-passive sector gear, 16-fixed base

### DETAILED DESCRIPTION OF THE EMBODIMENTS

### Example 1

A manual plate cutting machine comprises a workbench 1, a handle 2 and a cutter. In example 1, the workbench 1 is rectangular and cylindrical. The front end of the workbench 1 is provided with a fixed base 16, which is detachable from the workbench 1. A front support 4 and a rear support 5 are mounted at regular intervals on the workbench 1 and along the extending direction of the workbench 1. One end of the handle 2 is in gear shape, which is an active sector gear 6; and the active sector gear 6 is in shaft connection with the front support 4 and it can rotate around the front support 4. The cutter comprises a cutter holder 7 and a cutter body 8. The cutter body 8 is mounted below the cutter holder 7, and one end of the cutter holder 7 is in a gear shape, which is a passive sector gear 15, engaged with the active sector gear 6, and the other end of the cutter holder 7 is in shaft connection with the rear support 5, to rotate around the rear support 5.

When cutting, raising the handle 2, the active sector gear 6 will rotate counterclockwise, to drive the passive sector gear 15 to rotate clockwise, and the cutter is lifted, then place the plate to be cut below the cutter body 8, press down the handle 2, the active sector gear 6 rotates clockwise to drive the passive sector gear 15 to rotate counterclockwise, the cutter body is pressed down to cut the plate.

A stop block 13 is provided at the lower end of the handle 2. A limiting groove is accordingly provided on the cutter holder 7, and the position of the limiting groove is fitted with the stop block 13. When pressing down the handle, the stop block 13 will fall into the limiting groove. The stop block 13 is a protrusion with a certain height. When pressing down the handle 2, the stop block 13 and the limiting groove will limit the rotation of the handle 2. When an operator continues to exert force on the handle 2, it will not continue to transmit to the workbench from the cutter body 8, extending the service life of the cutter body 8 and the workbench 1.

A handle fixing ring 14 is provided at the tail end of the workbench 1, which can rotate around the tail end of the workbench 1. For the size of the handle fixing ring, it is appropriate that the handle fixing ring 14 can be secured at the top of the handle 2 when pressing down the handle 2 fully. After cutting operation, rotate the handle fixing ring 14 to be secured at the top of the handle 2 to fix it, and the cutter body 8 is in a closed state, to ensure the safety for carrying and transportation.

### Example 2

Different from example 1, the manual plate cutting machine further comprises a support frame 3 with the same height as the workbench 1, and a support frame suspension mechanism 9 is provided at the sidewall of the workbench 1. In example 2, two suspension holes are provided at the sidewall of the support frame 3. The support frame suspension mechanism 9 is two axial protrusions with the equal distance from the suspension holes, and the suspension holes can hung on the axial protrusions.

Further, the manual plate cutting machine still comprises a plate clamping mechanism which includes a clamping plate 10 in shaft connection with the workbench 1 through a clamping plate mounting shaft 12, and the clamping plate can rotate around the clamping plate mounting shaft 12.

The thickness of floor boards varies, including 8 mm, 10 mm, 12 mm, 15 mm, 18 mm, etc. To make the clamping plate 10 to secure floor boards of different thickness, an elastic member 11 is mounted at the low end face of the clamping plate 10.

When cutting, the support frame 3 is padded below the floor board; and the support frame 3 and the workbench 1 jointly support the floor board; by rotating the clamping plate 10, secure it to on the floor board. The support frame 3, workbench 1 and clamping plate 10 can work together to fix the position of the floor board, to prevent displacement of floor board when cutting.

1. A manual plate cutting machine, comprising a workbench, a handle and a cutter, a front support and a rear support mounted on the workbench at intervals, wherein one end of the handle is in a gear shape, which is an active sector gear, coupled with the front support;
the cutter comprises a cutter holder and a cutter body, the cutter body is mounted below the cutter holder, and one end of the cutter holder is in a gear shape, which is a passive sector gear, engaged with the active sector gear, and the other end of the cutter holder is coupled with the rear support.

2. The manual plate cutting machine according to claim 1, wherein a stop block is provided at a lower end of the handle.

3. The manual plate cutting machine according to claim 1, wherein a handle fixing ring is provided at a tail end of the workbench, can rotating around the tail end of the workbench.

4. The manual plate cutting machine according to claim 1, further comprising a support frame with the same height as the workbench, and a support frame suspension mechanism is provided at a sidewall of the workbench.

5. The manual plate cutting machine according to claim 4, further comprising a plate clamping mechanism which includes a clamping plate vertically shaft connected with the workbench, and an elastic member is mounted at a low end face of the clamping plate.
